(19) United States
(12) Patent Application Publication
(10) Pub. No.: US 2010/0289789 A1
(43) Pub. Date: Nov. 18, 2010

(54) PLASMA DISPLAY DEVICE

(75) Inventors: Sang Yoon Soh, Gumi-si (KR); Muk Hee Kim, Gumi-si (KR); Jeong Ho Lee, Gumi-si (KR); Jun Ho Park, Gumi-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/681,064

(22) PCT Filed: Dec. 23, 2008
(86) PCT No.: PCT/KR2008/007610

§ 371 Date: May 17, 2010

(30) Foreign Application Priority Data
Apr. 7, 2008 (KR) 10-2008-0032169

(51) Int. Cl. G09G 3/28; G09G 5/00

(52) U.S. Cl. 345/212; 345/60

(57) ABSTRACT

A plasma display device is provided. The plasma display device includes a plasma display panel (PDP) including an upper substrate, on which first and second electrodes are formed, and a lower substrate, on which a third electrode is formed; and a driving unit applying a sustain signal to the first and second electrodes, wherein a negative voltage signal and a positive voltage signal are applied to the first and second electrodes, respectively, after a number of sustain discharges caused by the sustain signal. Therefore, it is possible to efficiently accumulate space charges on each electrode and thus to address the problems associated with a shortage of wall charges such as a misdischarge and a dark discharge.

### TECHNICAL FIELD

The present invention relates to a plasma display device, and more particularly, to a plurality of driving signals for driving a plasma display panel (PDP).

### BACKGROUND ART

Plasma display panels (PDPs) generate images by exciting phosphors with the use of vacuum ultraviolet (VUV) rays generated by a discharge of a mixed inert gas.

PDPs are easy to manufacture as large-dimension thin flat displays. In addition, PDPs can provide high luminance and high light emission efficiency, compared to other flat panel displays. In particular, alternating current (AC) surface discharge-type tri-electrode PDPs accumulate wall charges on their surfaces and may thus be able to protect electrons from sputtering caused by a gas discharge. Therefore, AC surface discharge-type tri-electrode PDPs can be driven with a low voltage and can provide a long lifetime.

In order to realize various grayscale levels, PDPs may be driven in a time-division manner using a reset period for initializing all discharge cells, an address period for selecting a number of discharge cells, and a sustain period for enabling the selected discharge cells to cause a number of sustain discharges.

However, conventional PDPs may cause a misdischarge after a discharge due to a shortage of wall charges. As a result, the luminance of dark areas in an image may increase, and the contrast ratio of an image may deteriorate. That is, the quality of images image displayed by conventional PDPs may deteriorate.

### DISCLOSURE OF INVENTION

### Technical Problem

The present invention provides a plasma display device which can efficiently accumulate space charges on each electrode and can thus stably apply a number of driving signals for preventing the occurrence of a misdischarge to a plasma display panel (PDP).

### Technical Solution

According to an aspect of the present invention, there is provided a plasma display device including a PDP including an upper substrate, on which first and second electrodes are formed, and a lower substrate, on which a third electrode is formed; and a driving unit applying a sustain signal to the first and second electrodes, wherein a negative voltage signal and a positive voltage signal are applied to the first and second electrodes, respectively, after a number of sustain discharges caused by the sustain signal.

According to another aspect of the present invention, there is provided a plasma display device including a PDP including an upper substrate, on which first and second electrodes are formed, and a lower substrate, on which a third electrode is formed; and a driving unit applying a sustain signal to the first and second electrodes, wherein a negative voltage signal and a positive voltage signal are applied to the first and second electrodes, respectively, after the occurrence of a number of sustain discharges caused by the sustain signal and no discharge occurs in the PDP during the application of the negative and positive voltage signals.

According to another aspect of the present invention, there is provided a plasma display device including a PDP including an upper substrate, on which first and second electrodes are formed, and a lower substrate, on which a third electrode is formed; and a driving unit applying a sustain signal to the first and second electrodes, wherein a time period during which the last one of a plurality of sustain pulses of the sustain signal is applied includes a first time period during which a sustain voltage is applied to the second electrode and a second time period during which a negative voltage signal and a positive voltage signal are applied to the first and second electrodes, respectively, the second time period following the first time period.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a perspective view of a plasma display panel (PDP) according to an exemplary embodiment of the present invention;

FIG. 2 illustrates a cross-sectional view for explaining the arrangement of electrodes in a PDP;

FIG. 3 illustrates a timing diagram for explaining a time-division method of driving a PDP in which a frame is divided into a plurality of sub-fields;

FIG. 4 illustrates a timing diagram of the waveforms of a plurality of driving signals for driving a PDP;

FIGS. 5 and 6 illustrate timing diagrams of the waveforms of a plurality of driving signals for driving a PDP, according to exemplary embodiments of the present invention;

FIGS. 7 through 11 illustrate timing diagrams of the waveforms of a plurality of driving signals for driving a PDP, according to other exemplary embodiments of the present invention;

FIGS. 12 through 16 illustrate timing diagrams of the waveforms of a plurality of driving signals for driving a PDP, according to other exemplary embodiments of the present invention;

FIGS. 17A and 17B illustrate diagrams for explaining the distribution of wall charges in a discharge cell during a sustain period; and

FIG. 17C illustrates a diagram for explaining the distribution of wall charges in a discharge cell after a second time period.

### BEST MODE FOR CARRYING OUT THE INVENTION

The present invention will hereinafter be described in detail with reference to the accompanying drawings in which exemplary embodiments of the invention are shown.

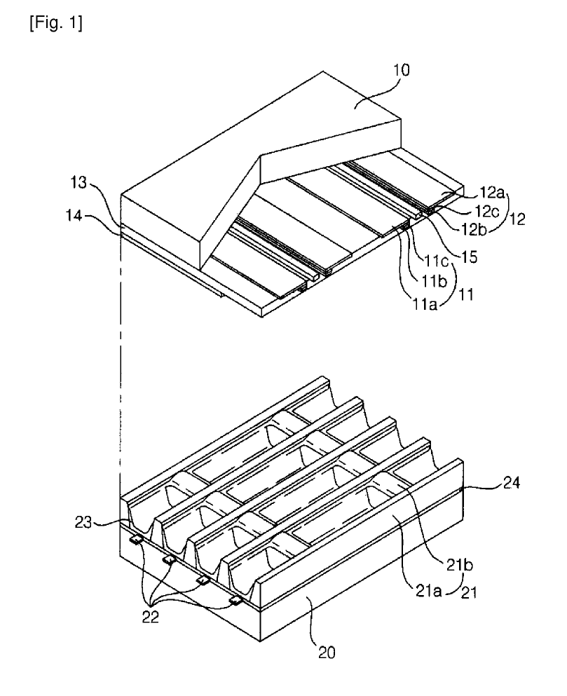

FIG. 1 illustrates a perspective view of a plasma display panel according to an exemplary embodiment of the present invention. Referring to FIG. 1, the PDP includes an upper substrate 10, a plurality of electrode pairs which are formed on the upper substrate 10 and consist of a scan electrode 11 and a sustain electrode 12 each; a lower substrate 20; and a plurality of address electrodes 22 which are formed on the lower substrate 20.

Each of the electrode pairs includes transparent electrodes 11a and 12a and bus electrodes 11b and 12b. The transparent electrodes 11a and 12a may be formed of indium-tin-oxide (ITO). The bus electrodes 11b and 12b may be formed of a metal such as silver (Ag) or chromium (Cr) or may include a stack of chromium/copper/chromium copper/chromium (Cr/Cu/Cr) or a stack of chromium/aluminium/chromium (Cr/Al/Cr). The bus electrodes 11b and 12b are respectively formed on the transparent electrodes 11a and 12a and reduce a voltage drop caused by the transparent electrodes 11a and 12a which have a high resistance.

Each of the electrode pairs may include the bus electrodes 11b and 12b only. In this case, the manufacturing cost of the PDP can be reduced by not using the transparent electrodes 11a and 12a. The bus electrodes 11b and 12b may be formed of various materials other than those set forth herein, e.g., a photosensitive material.

Black matrices are formed on the upper substrate 10. The black matrices perform a light shied function by absorbing external light incident upon the upper substrate 10 so that light reflection can be reduced. In addition, the black matrices enhance the purity and contrast of the upper substrate 10.

More specifically, the black matrices include a first black matrix 15 which overlaps a plurality of barrier ribs 21, a second black matrix 11c which is formed between the transparent electrode 11a and the bus electrode 11b of each of the scan electrodes 11, and a second black matrix 12c which is formed between the transparent electrode 12a and the bus electrode 12b. The first black matrix 15 and the second black matrices 11c and 12c, which can also be referred to as black layers or black electrode layers, may be formed at the same time and may be physically connected. Alternatively, the first black matrix 15 and the second black matrices 11c and 12c may not be formed at the same time, and may not be physically connected.

If the first black matrix 15 and the second black matrices 11c and 12c are physically connected, the first black matrix 15 and the second black matrices 11c and 12c may be formed of the same material. On the other hand, if the first black matrix 15 and the second black matrices 11c and 12c are physically separated, the first black matrix 15 and the second black matrices 11c and 12c may be formed of different materials.

An upper dielectric layer 13 and a passivation layer 14 are deposited on the upper substrate 10 on which the scan electrodes 11 and the sustain electrodes 12 are formed in parallel with one other. Charged particles generated as a result of a discharge accumulate in the upper dielectric layer 13. The upper dielectric layer 13 may protect the electrode pairs. The passivation layer 14 protects the upper dielectric layer 13 from sputtering of the charged particles and enhances the discharge of secondary electrons.

The address electrodes 22 are formed and intersects the scan electrode 11 and the sustain electrodes 12. A lower dielectric layer 23 and the barrier ribs 21 are formed on the lower substrate 20 on which the address electrodes 22 are formed.

A phosphor layer is formed on the lower dielectric layer 23 and the barrier ribs 21. The barrier ribs 21 include a plurality of vertical barrier ribs 21a and a plurality of horizontal barrier ribs 21b that form a closed-type barrier rib structure. The barrier ribs 21 define a plurality of discharge cells and prevent ultraviolet (UV) rays and visible rays generated by a discharge from leaking into the discharge cells.

The present invention can be applied to various barrier rib structures, other than that set forth herein. For example, the present invention can be applied to a differential barrier rib structure in which the height of vertical barrier ribs 21a is different from the height of horizontal barrier ribs 21b, a channel-type barrier rib structure in which a channel that can be used as an exhaust passage is formed in at least one vertical or horizontal barrier rib 21a or 21b, and a hollow-type barrier rib structure in which a hollow is formed in at least one vertical or horizontal barrier rib 21a or 21b. In the differential barrier rib structure, the height of horizontal barrier ribs 21b may be greater than the height of vertical barrier ribs 21a. In the channel-type barrier rib structure or the hollow-type barrier rib structure, a channel or a hollow may be formed in at least one horizontal barrier rib 21b.

Red (R), green (G), and blue (B) discharge cells are arranged in a straight line. However, the present invention is not restricted to this. For example, R, G, and B discharge cells may be arranged as a triangle or a delta. Alternatively, R, G, and B discharge cells may be arranged as a polygon such as a rectangle, a pentagon, or a hexagon.

The phosphor layer is excited by UV rays that are generated upon a gas discharge. As a result, the phosphor layer generates one of R, G, and B rays. A discharge space is provided between the upper and lower substrates 10 and 20 and the barrier ribs 21. A mixture of inert gases, e.g., a mixture of helium (He) and xenon (Xe), a mixture of neon (Ne) and Xe, or a mixture of He, Ne, and Xe is injected into the discharge space.

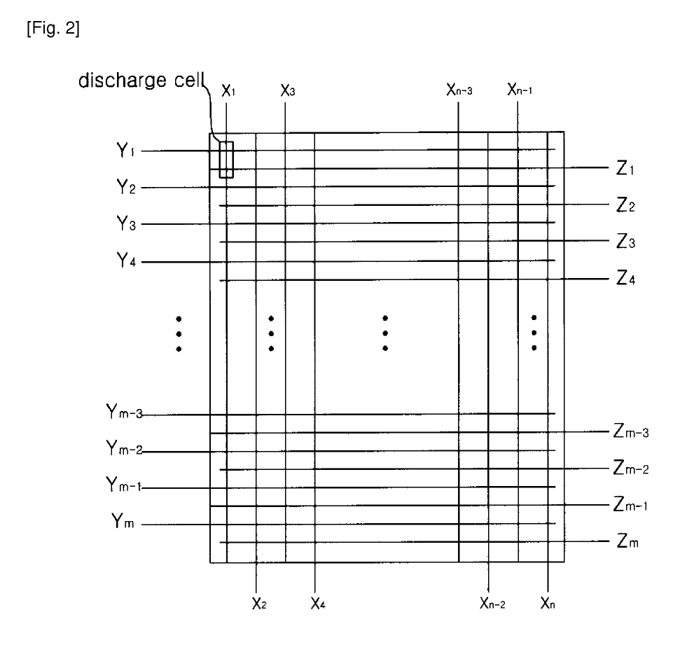

FIG. 2 illustrates the arrangement of electrodes in a PDP. Referring to FIG. 2, a plurality of discharge cells that constitute a PDP may be arranged in a matrix. The discharge cells are respectively disposed at the intersections between a plurality of scan electrode lines Y₁ through Yₘ and a plurality of address electrode lines X₁ through Xₙ or the intersections between a plurality of sustain electrode lines Z₁ through Zₘ and the address electrode lines X₁ through Xₙ. The scan electrode lines Y₁ through Yₘ may be sequentially or simultaneously driven. The sustain electrode lines Z₁ through Zₘ may be simultaneously driven. The address electrode lines X₁ through Xₙ may be divided into two groups: a group including odd-numbered address electrode lines and a group including even-numbered address electrode lines. The address electrode lines X₁ through Xₙ may be driven in units of the groups or may be sequentially driven.

The electrode arrangement illustrated in FIG. 2, however, is exemplary, and thus, the present invention is not restricted to this. For example, the scan electrode lines Y₁ through Yₘ may be driven using a dual scan method in which two of a plurality of scan lines are driven at the same time. The address electrode lines X₁ through Xₙ may be divided into two groups: a group including upper address electrode lines that are disposed in the upper half of a PDP and a group including lower address electrode lines that are disposed in the lower half of the PDP. Then, the address electrode lines X₁ through Xₙ may be driven in units of the two groups.

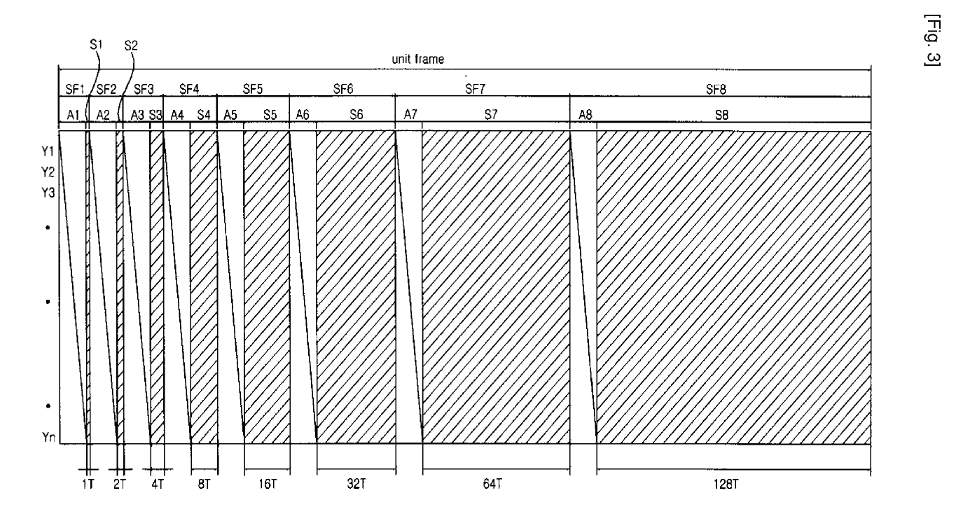

FIG. 3 illustrates a timing diagram for explaining a time-division method of driving a PDP in which a frame is divided into a plurality of sub-fields. Referring to FIG. 3, a unit frame is divided into a predefined number of sub-fields, for example, eight sub-fields SF1 through SF8, in order to realize a time-division grayscale display. Each of the sub-fields SF1 through SF8 is divided into a reset period (not shown), an address period (A1, . . . A8), and a sustain period (S1, . . . S8).

Not all of the sub-fields SF1 through SF8 may have a reset period. For example, only the first sub-field SF1 may have a reset period, or only the first sub-field and a middle sub-field may have a reset period.

During each of the address periods A1 through A8, a display data signal is applied to an address electrode X, and a scan pulse is applied to a scan electrode Y so that wall charges can be generated in a discharge cell.

During each of the sustain periods S1 through S8, a sustain pulse is alternately applied to the scan electrode Y and a sustain electrode Z so that a discharge cell can cause a number of sustain discharges.

The luminance of a PDP is proportional to the total number of sustain discharge pulses allocated throughout the sustain discharge periods S1 through S8. Assuming that a frame for one image includes eight sub-fields and is represented with 256 grayscale levels, 1, 2, 4, 8, 16, 32, 64, and 128 sustain pulses may be respectively allocated to the sustain periods S1, S2, S3, S4, S5, S6, S7, and S8. In order to realize a grayscale level of 133, a plurality of discharge cells may be addressed during the first, third, and eighth sub fields SF1, SF3, and SF8 so that they can cause a total of 133 sustain discharges.

The number of sustain discharges allocated to each of the sub-fields SF1 through SF8 may be determined according to a weight allocated to a corresponding sub field through automatic power control (APC). Referring to FIG. 3, a frame is divided into eight sub-fields, but the present invention is not restricted to this. In other words, the number of sub-fields in a frame may be varied. For example, a PDP may be driven by dividing each frame into more than eight sub-fields (e.g., twelve or sixteen sub-fields).

The number of sustain discharges allocated to each of the sub-fields SF1 through SF8 may be varied according to gamma and other characteristics of a PDP. For example, a grayscale level of 6, instead of a grayscale level of 8, may be allocated to the sub-field SF4, and a grayscale level of 34, instead of a grayscale level of 32, may be allocated to the sub-field SF6.

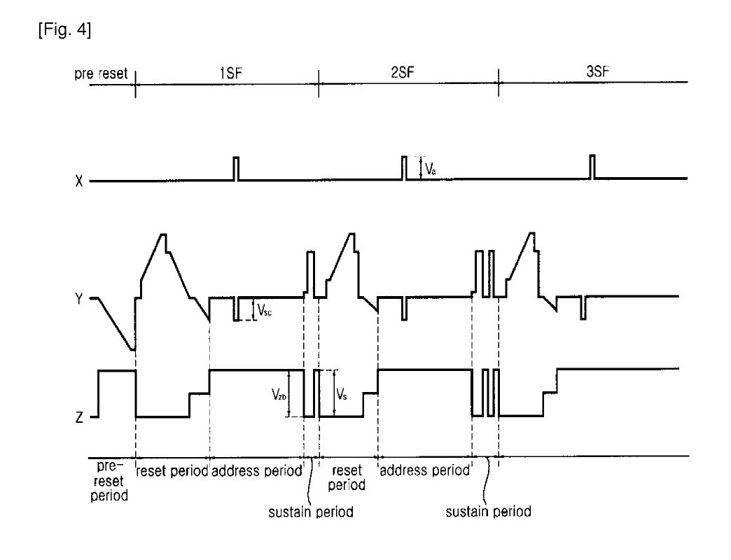

FIG. 4 illustrates a timing diagram of the waveforms of driving signals used to drive a PDP, according to an embodiment of the present invention. Referring to FIG. 4, a pre-reset period is followed by a first sub-field. During the pre-reset period, positive wall charges are generated on scan electrodes Y and negative wall charges are generated on sustain electrodes Z. Each sub-field includes a reset period for initializing the discharge cells of a previous frame with reference to the distribution of wall charges generated during the pre-reset period, an address period for selecting a number of discharge cells, and a sustain period for enabling the selected discharge cells to cause a number of sustain discharges.

A reset period includes a set-up period during and a set-down period. During a set-up period, a ramp-up waveform is applied to all the scan electrodes Y at the same time so that all discharge cells each can cause a weak discharge, and that wall charges can be generated in the discharge cells, respectively.

During a set-down period, a ramp-down waveform whose voltage decreases from a positive voltage that is lower than a peak voltage of the ramp-up waveform is applied to all the scan electrodes Y so that each of the discharge cells can cause an erase discharge, and that whichever of the wall charges generated during the set-up period and space charges are unnecessary can be erased.

During an address period, a negative scan signal is applied to the scan electrodes Y, and at the same time, a positive data signal is applied to the address electrodes X. Due to the difference between the negative scan signal and the positive data signal and the wall charges generated during the reset period, an address discharge occurs, and a cell is selected. During the set-down period and the address period, a signal which maintains a sustain voltage is applied to the sustain electrodes Z.

During a sustain period, a sustain pulse is alternately applied to the scan electrodes Y and the sustain electrodes Z so that surface discharges can occur between the scan electrodes Y and the respective sustain electrodes Z as sustain discharges.

The waveforms illustrated in FIG. 4 are exemplary, and thus, the present invention is not restricted thereto. For example, the pre-reset period may be optional. In addition, the polarities and voltages of driving signals used to drive a PDP are not restricted to those illustrated in FIG. 4, and may be altered in various manners. An erase signal for erasing wall charges may be applied to each of the sustain electrodes Z after a sustain discharge. The sustain signal may be applied to either the scan electrodes Y or the sustain electrodes Z, thereby realizing a single-sustain driving method.

As described above, each sub-field for driving a PDP includes a reset period, an address period and a sustain period. In general, a frame includes eight to twelve sub-fields and realizes a single image. During the reset period of each sub-field, a wall-charge state of each discharge cell is controlled in order to smoothly perform addressing on each discharge cell. During the address period of each sub-field, scanning is performed on a line-by-line basis in order to choose on-cells and off-cells, and thus, wall charges are generated in on-cells so as to perform a sustain operation with the aid of address discharges. During the sustain period of each sub-field, a discharge for displaying an image is performed in a number of discharge cells that are addressed during the address period of each sub-field.

According to the National Television Standards Committee (NTSC) scheme, a vertical synchronization signal Vsync for an image signal has a period of 16.67 ms. A PDP driving control circuit receives the vertical synchronization signal Vsync and generates a control signal based on the vertical synchronization signal Vsync. If a vertical synchronization signal Vsync having a normal period is received, a PDP driving control circuit may operate normally.

Once a vertical synchronization signal Vsync is received, a plurality of sub fields are generated. Thus, a pre-reset period may be generated immediately after the reception of a vertical synchronization signal Vsync.

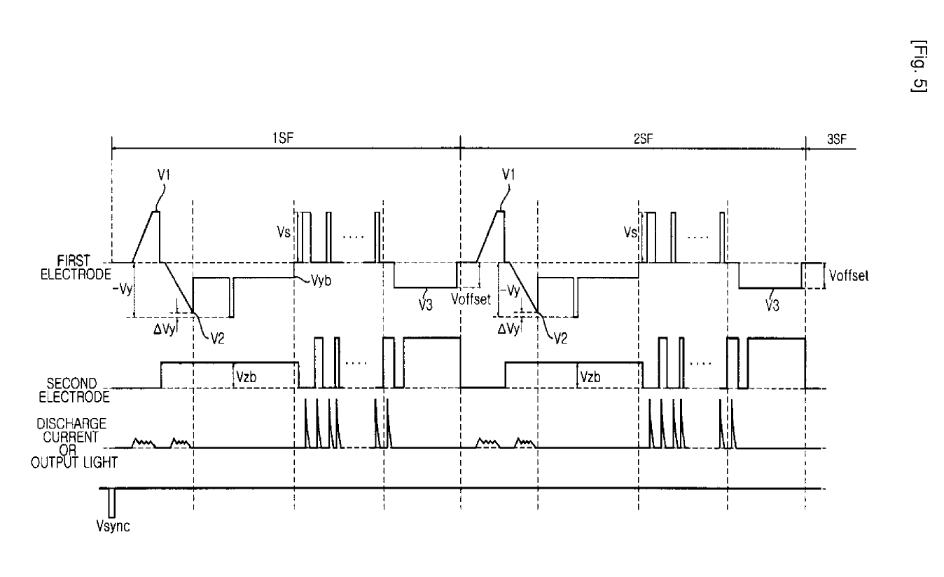

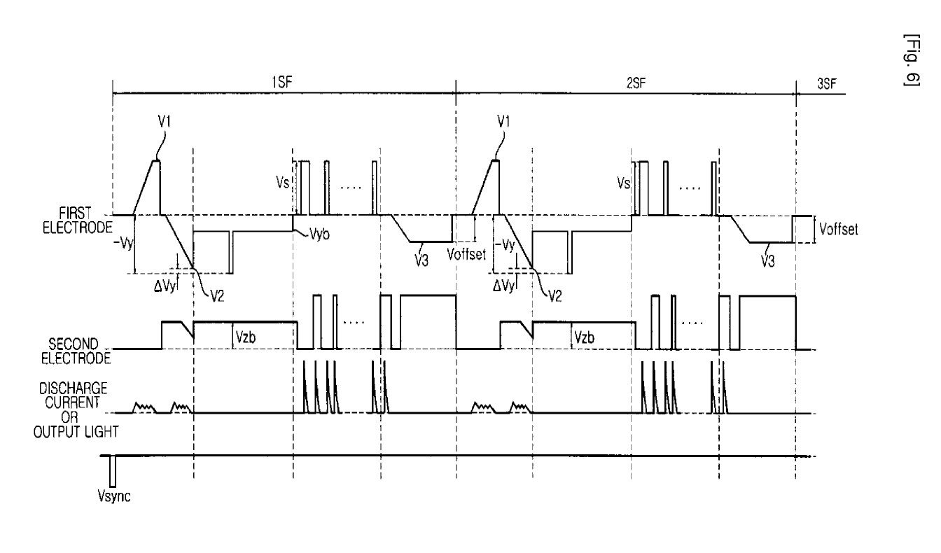

FIGS. 5 and 6 illustrate timing diagrams of a plurality of driving signals for driving a PDP, according to exemplary embodiments of the present invention.

A plasma display device according to an exemplary embodiment of the present invention includes a PDP and a driving unit. The PDP includes an upper substrate on which first and second electrodes are formed and a lower substrate on which a third substrate is formed. The driving unit applies a sustain signal to the first and second electrodes.

When the sustain signal is applied to the second electrode, a sustain discharge occurs. Thereafter, a negative voltage signal and a positive voltage signal are applied to the first and second electrodes, respectively.

A plurality of driving signals for driving a PDP, according to an exemplary embodiment of the present invention may be applied during at least one of a plurality of sub-fields of a frame. Referring to FIG. 5, when a vertical synchronization signal Vsync is received, the application of the driving signals begins at the beginning of a reset period of a first sub-field 1SF. The driving signals may have the same waveforms throughout the first sub-field 1SF and a second sub-field 2SF.

A time period during which the negative voltage signal is applied to the second electrode may partially overlap with a time period during which the negative voltage signal is applied to the first electrode. That is, the beginning of the time period during which the negative voltage signal is applied to the second electrode may not necessarily coincide with the beginning of the time period during which the negative voltage signal is applied to the first electrode, and the end of the time period during which the negative voltage signal is applied to the second electrode may not necessarily coincide with the end of the time period during which the negative voltage signal is applied to the first electrode.

During a sustain period, a sustain signal having a sustain voltage Vs is alternately applied to the first and second electrodes, and thus, a number of surface discharges occur between the first and second electrodes as sustain discharges.

Due to the sustain discharges, sufficient wall charges accumulate on the first and second electrodes, and the polarity of the wall charges in each of the first and second electrodes may be stably maintained.

After the last sustain discharge, the negative voltage signal is applied to the first electrode. The time period during which the negative voltage signal is applied to the first electrode may overlap with the time period during which the negative voltage signal is applied to the second electrode. Due to the positive and negative voltage signals, positive wall charges accumulate on the first electrode, and negative wall charges accumulate on the second electrode.

The absolute value of the voltage of the negative voltage signal may be less than the absolute value of the sustain voltage Vs. If the absolute value of the voltage of the negative voltage signal is too large, a discharge may occur due to a large difference between the voltage of the negative voltage signal and the voltage of the positive voltage signal. On the other hand, if the absolute value of the voltage of the negative voltage signal is too small, wall charges may not be able to accumulate sufficiently on the first and second electrodes, thereby increasing the probability of the occurrence of a misdischarge, and particularly, the probability of discharge cells that are supposed to be turned on failing to be turned on.

The absolute value of the voltage of the negative voltage may be 0.47-0.74 times greater than the absolute value of the sustain voltage Vs.

If a discharge occurs during the application of the negative voltage signal, light leak may occur. In this case, the luminance of dark areas in an image may increase, and thus, the properties of a display device such as contrast ratio may deteriorate.

The voltage of the negative voltage signal may be substantially the same as the sustain voltage Vs. In this exemplary embodiment, there is no need to provide any additional circuit for applying a voltage. Thus, it is possible to simplify the structure and the operation of a plasma display device.

Referring to FIG. 6, a reset signal may be applied to the first electrode. The voltage of the reset signal may gradually increases to a first voltage V1 during a set-up period of a reset period, and may gradually decreases to a second voltage V2 during a set-down period of a reset period. The voltage of the negative voltage signal, which is applied to the first electrode, may be lower than the second voltage V2.

The negative voltage signal may be divided into two portions: a first portion whose voltage gradually decreases to a third voltage V3 and a second portion whose voltage is maintained at the third voltage V3. In this case, the slope of the first portion of the negative voltage signal may be substantially the same as the slope of the reset signal during a set-down period. Thus, this exemplary embodiment can be implemented without the need of an additional circuit.

A bias voltage signal Vzb is applied to the second electrode during a set-down period. The voltage of the bias voltage signal Vzb may be uniformly maintained or may gradually decrease during a set-down period.

A surface discharge and an opposed discharge may both occur at the end of a set-down period. As a result, a spot misdischarge may also occur at the end of a set-down period. In order to prevent the occurrence of a spot misdischarge, the second voltage may be set low.

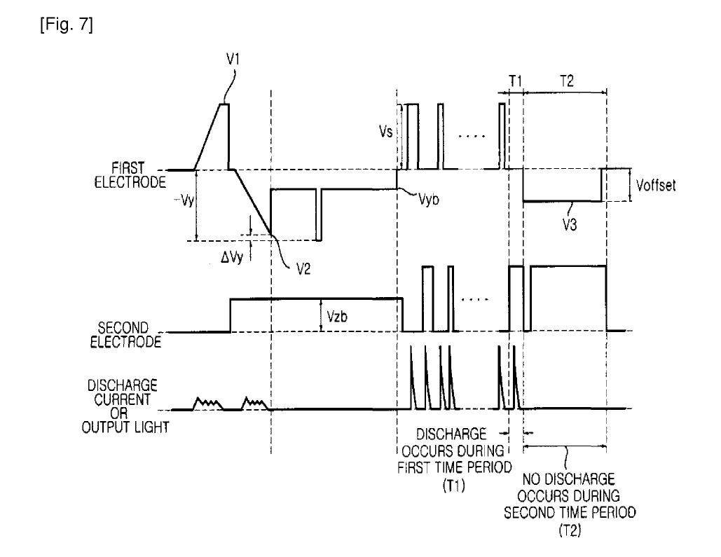

FIGS. 7 through 11 illustrate timing diagrams of the waveforms of a plurality of driving signals for driving a PDP, according to other exemplary embodiments of the present invention.

Referring to FIG. 7, a plasma display device according to an exemplary embodiment of the present invention includes a PDP and a driving unit. The PDP includes an upper substrate on which first and second electrodes are formed and a lower substrate on which a third substrate is formed. The driving unit applies a sustain signal to the first and second electrodes.

A number of sustain discharges occur in the second electrode due to the sustain signal. After the sustain discharges, a negative voltage signal and a positive voltage signal may be applied to the first and second electrodes, respectively. No discharge occurs in the PDP during the application of the negative voltage signal or the positive voltage signal.

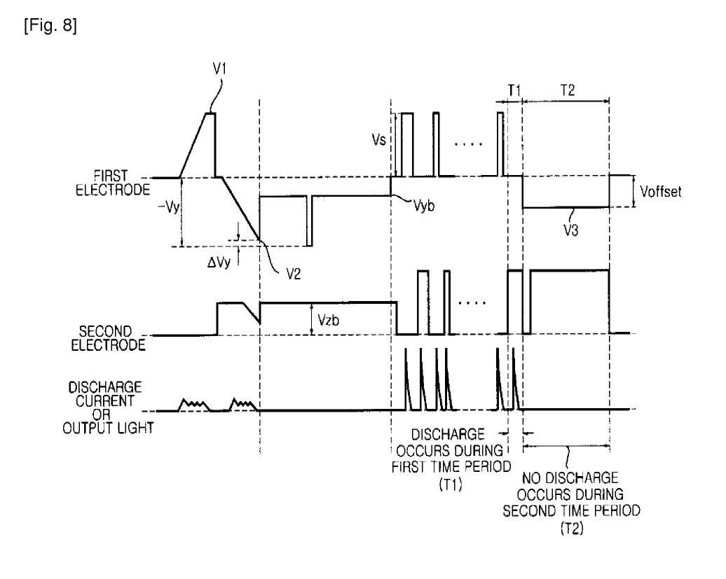

Referring to FIGS. 7 and 8, a time period during which the negative voltage signal is applied to the second electrode may at least partially overlap with a time period during which the negative voltage signal is applied to the first electrode. That is, the beginning of the time period during which the negative voltage signal is applied to the second electrode may not necessarily coincide with the beginning of the time period during which the negative voltage signal is applied to the first electrode, and the end of the time period during which the negative voltage signal is applied to the second electrode may not necessarily coincide with the end of the time period during which the negative voltage signal is applied to the first electrode. In this case, it is possible to prevent the occurrence of a voltage picking phenomenon that may be caused by turning on or off the switching devices of the first and second electrodes at the same time. The end of the time period during which the negative voltage signal is applied to the first electrode may be set to be earlier than the end of a time period during which a sustain signal is applied to the second electrode in consideration of the application of a voltage to each of the first and second electrodes during a reset period.

The time period during which the negative voltage signal is applied may partially overlap with a time period during which a ground voltage is applied.

During the application of the negative voltage signal and the positive voltage signal signal, no discharge may occur in the PDP. Instead, during the application of the negative voltage signal and the positive voltage signal, wall charges may accumulate on the first and second electrodes while preventing the occurrence of a discharge.

The voltage of the positive voltage signal may be the same as a sustain voltage Vs. In this exemplary embodiment, there is no need to provide any additional circuit for applying a voltage. Thus, it is possible to simplify the structure and the operation of a plasma display device.

The absolute value of the voltage of the negative voltage signal may be less than the absolute value of the sustain voltage Vs. If the absolute value of the voltage of the negative voltage signal is too large, a discharge may occur due to a large difference between the voltage of the negative voltage signal and the voltage of the positive voltage signal. On the other hand, if the absolute value of the voltage of the negative voltage signal is too small, wall charges may not be able to accumulate sufficiently on the first and second electrodes, thereby increasing the probability of the occurrence of a misdischarge.

Table 1 below shows the relationship among the ratio of the absolute value of the voltage of the negative voltage signal and the absolute value of the sustain voltage Vs, the occurrence of a misdischarge and the occurrence of a discharge.

TABLE 1

| Ratio of Absolute Value of Voltage of | Occurrence | |
|---|---|---|
| Negative Voltage Signal and Absolute | of Mis- | Occurrence of |
| Value of Sustain Voltage | discharge | Discharge |
| 0.1 | ◯ | X |
| 0.15 | ◯ | X |
| 0.2 | ◯ | X |
| 0.25 | ◯ | X |
| 0.3 | ◯ | X |
| 0.35 | ◯ | X |
| 0.4 | ◯ | X |
| 0.45 | ◯ | X |
| 0.47 | X | X |
| 0.5 | X | X |
| 0.55 | X | X |
| 0.6 | X | X |
| 0.65 | X | X |
| 0.7 | X | X |
| 0.74 | X | X |
| 0.8 | X | ◯ |
| 0.85 | X | ◯ |
| 0.9 | X | ◯ |

Referring to Table 1, when the ratio of the absolute value of the voltage of the negative voltage signal and the absolute value of the sustain voltage Vs is within the range of 0.47-0.74, neither a misdischarge nor a discharge occurs. If the absolute value of the voltage of the negative voltage signal is too small, sufficient positive charges may not be able to accumulate on the first electrode, and thus, a misdischarge may occur due to a shortage of wall charges. Therefore, the absolute value of the voltage of the negative voltage may be 0.47-0.74 times greater than the absolute value of the sustain voltage Vs.

The voltage of the negative voltage signal may decrease in steps to a third voltage V3. In this case, since no voltage drops occurs, the time period during which the negative voltage signal is applied to the first electrode may increase, and thus, sufficient wall charges may be able to accumulate on the first electrode.

The voltage of the reset signal gradually increases to a first voltage V1 during a set-up period of a reset period and gradually decreases to a second voltage V2 during a set-down period of a reset period. The absolute value of the voltage of the negative voltage signal may be less than the absolute value of the second voltage.

A bias voltage signal Vzb may be applied to the second electrode during a set-down period. The voltage of the bias voltage signal Vzb may be uniformly maintained during a set-down period, as illustrated in FIG. 7. Alternatively, the second electrode may be floated, and thus, the voltage of the bias voltage signal Vzb may gradually decrease during a set-down period, as illustrated in FIG. 8.

A surface discharge and an opposed discharge may both occur at the end of a set-down period. As a result, a spot misdischarge may also occur at the end of a set-down period. In order to prevent the occurrence of a spot misdischarge, the second voltage may be set low.

If the second electrode is floated, the slope of the bias voltage signal Vzb during a set-down period may be the same as the slope of the reset signal during a set-down period.

Table 2 shows the relationship among the ratio of the absolute value of the voltage of the negative voltage signal and the absolute value of the second voltage V2, the occurrence of a misdischarge and the occurrence of a discharge.

TABLE 2

| Ratio of Absolute Value of Voltage of | Occurrence | |
|---|---|---|
| Negative Voltage Signal and Absolute | of A Mis- | Occurrence of |
| Value of Second Voltage | discharge | Discharge |
| 0.1 | ◯ | X |
| 0.15 | ◯ | X |
| 0.2 | ◯ | X |
| 0.25 | ◯ | X |
| 0.3 | ◯ | X |
| 0.35 | ◯ | X |
| 0.4 | ◯ | X |
| 0.45 | ◯ | X |
| 0.5 | X | X |
| 0.55 | X | X |
| 0.6 | X | X |
| 0.65 | X | X |
| 0.7 | X | X |
| 0.75 | X | X |
| 0.8 | X | X |
| 0.85 | X | X |
| 0.9 | X | ◯ |
| 0.95 | X | ◯ |

Referring to Table 2, if the ratio of the absolute value of the negative voltage signal and the absolute value of the second voltage V2 is less than 0.5, a misdischarge may occur due to a shortage of wall charges. On the other hand, if the ratio of the absolute value of the negative voltage signal and the absolute value of the second voltage V2 is greater than 0.85, a discharge may occur due to a large difference between the voltage of the negative voltage signal and the voltage of the positive voltage signal. Therefore, the absolute value of the voltage of the negative voltage signal may be 0.5-0.85 times greater than the absolute value of the second voltage V2.

The voltage of the negative voltage signal may be between the second voltage V2 and a scan bias voltage Vyb, which is applied to the first electrode during an address period.

The width of the last one of a plurality of sustain pulses may be set to be larger than the width of any one of the other sustain pulses. Therefore, it is possible to secure sufficient time period to apply the negative voltage signal and to accumulate sufficient wall charges on the first and second electrodes.

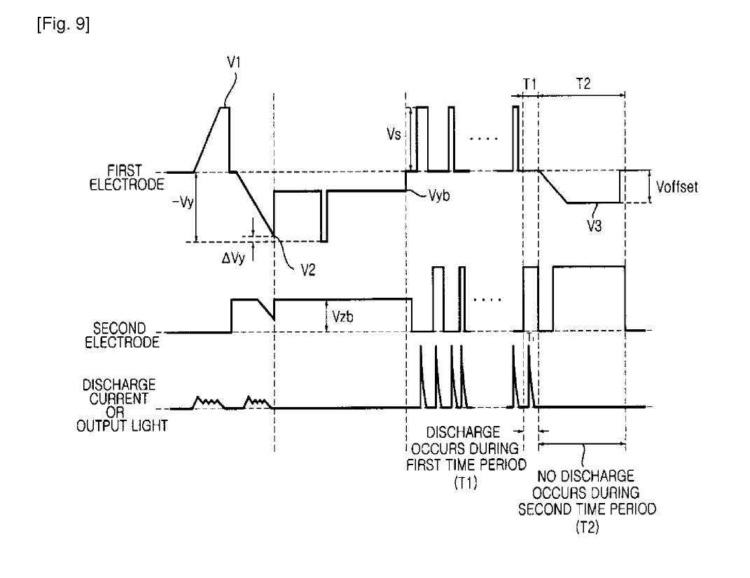

FIG. 9 illustrates a timing diagram of the waveforms of a plurality of driving signals for driving a PDP, according to another exemplary embodiment of the present invention. Referring to FIG. 9, a negative voltage signal may be divided into two signal portions: a first portion whose voltage gradually decreases to a third voltage V3 and a second portion whose voltage is maintained at the third voltage V3. In this case, the slope of the first portion of the negative voltage signal may be substantially the same as the slope of the reset signal during a set-down period. Thus, this exemplary embodiment can be implemented without the need of an additional circuit.

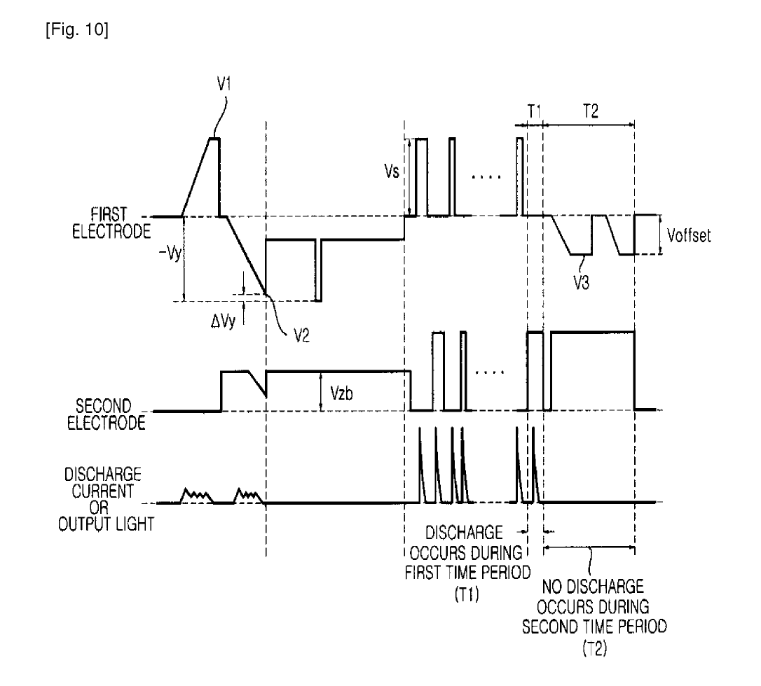

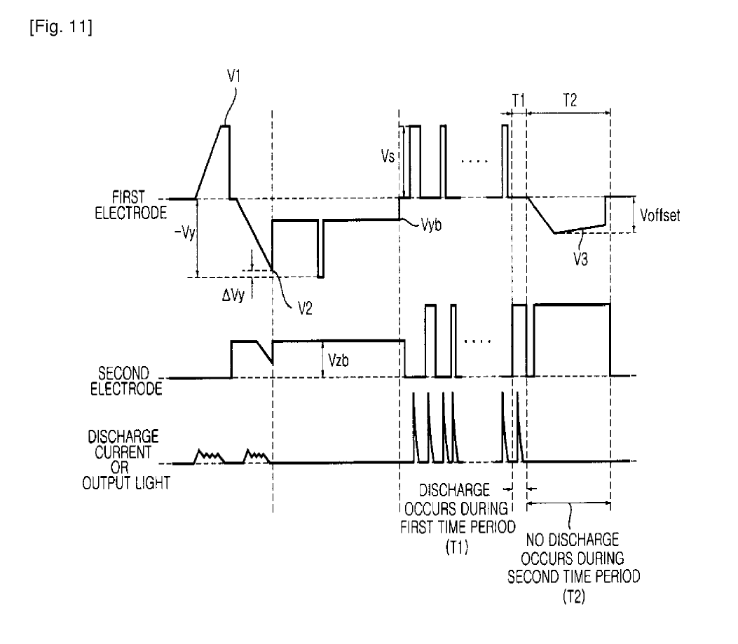

FIGS. 10 and 11 illustrate timing diagrams of the waveforms of a plurality of driving signals for driving a PDP, according to exemplary embodiments of the present invention

Referring to FIG. 10, a negative voltage signal may be divided into two or more negative voltage portions and a ground voltage portion. The accumulation of wall charges may be affected by the length of the negative voltage portions. Thus, it is possible to control the amount of wall charge accumulated and the length of a second time period T2 by adjusting the length of the negative voltage portions.

Referring to FIG. 11, a time period during which a negative voltage signal is applied to the first electrode is divided into a third time period during which the voltage of the negative voltage signal gradually decreases and a fourth time period during which the voltage of the negative voltage signal gradually increases. The fourth time period follows the third time period.

If a switching device for supplying a voltage −Vy to the first electrode is opened and thus floated after the application of the negative voltage signal, the voltage of the negative voltage signal may gradually increases from its minimum level.

If the voltage of the negative voltage signal is too high, a discharge may occur due to a large difference between the voltage of the negative voltage signal and the voltage of a positive voltage signal, which is applied to the second electrode. Thus, it is necessary to accumulate sufficient wall charges by applying a negative voltage signal whose voltage gradually increases with a gentle slope and preventing the voltage of the negative voltage signal from increasing too excessively. It is possible to reduce the difference between the voltage of the negative voltage signal and the voltage of the positive voltage signal by adjusting the time to perform floating so as to control the second time period T2 and to prevent an excessive accumulation of wall charges. The length of the second time period T2 may be adjusted so that an appropriate amount of wall charge can accumulate.

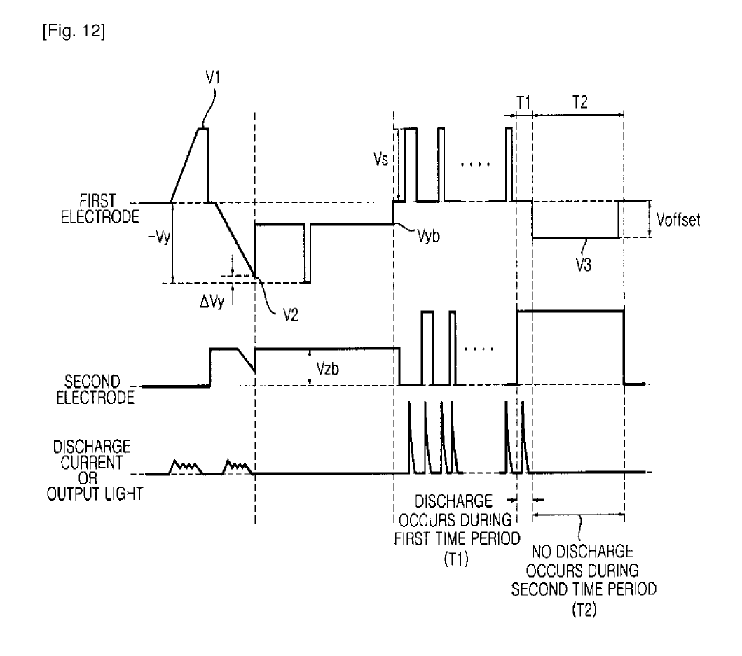

FIGS. 12 through 16 illustrate timing diagrams of the waveforms of a plurality of driving signals for driving a PDP, according to other exemplary embodiments of the present invention.

Referring to FIG. 12, a sustain signal is applied to the first and second electrodes. A time period during which the last one of a plurality of sustain pulses of the sustain signal may be divided into a first time period T1 during which a sustain voltage Vs is applied to the second electrode and a second time period T2 during which a negative voltage signal and a positive voltage signal are applied to the first and second electrodes, respectively. The second time period T2 follows the first time period T1.

During the second time period T2, unlike during the first time period T1, no discharge occurs. The second time period T2 may be a time period for accumulating wall charges on the first and second electrodes during the second time period T2 while preventing the occurrence of a discharge.

The positive voltage signal may have the same voltage as a sustain voltage Vs. It is possible to simplify the structure and the operation of a plasma display device by uniformly maintaining the voltage of the positive voltage signal at the sustain voltage Vs during the first time period T1.

The voltage of the negative voltage signal may decrease in steps to a third voltage V3. In this case, no voltage drop occurs. Thus, the time period during which the negative voltage signal is applied to the first electrode may increase, and thus, sufficient wall charges may be able to accumulate.

The absolute value of the voltage of the negative voltage signal may be less than the absolute value of the sustain voltage Vs. If the absolute value of the voltage of the negative voltage signal is too large, a discharge may occur due to a large difference between the voltage of the negative voltage signal and the voltage of the positive voltage signal. On the other hand, if the absolute value of the voltage of the negative voltage signal is too small, wall charges may not be able to accumulate sufficiently on the first and second electrodes, thereby increasing the probability of the occurrence of a misdischarge. Therefore, as described above with reference to Table 1, the absolute value of the voltage of the negative voltage may be 0.47-0.74 times greater than the absolute value of the sustain voltage Vs.

The voltage of a reset signal gradually increases to a first voltage V1 during a set-up period of a reset period, and gradually decreases to a second voltage V2 during a set-down period of a reset period. The absolute value of the voltage of the negative voltage signal may be less than the absolute value of the second voltage V2.

A bias voltage signal Vzb may be applied to the second electrode during a set-down period. The voltage of the bias voltage signal Vzb may be uniformly maintained during a set-down period. Alternatively, the second electrode may be floated, and thus, the voltage of the bias voltage signal Vzb may gradually decrease during a set-down period, as illustrated in FIG. 12.

A surface discharge and an opposed discharge may both occur at the end of a set-down period. As a result, a spot misdischarge may also occur at the end of a set-down period. In order to prevent the occurrence of a spot misdischarge, the second voltage may be set low.

If the second electrode is floated, the slope of the bias voltage signal Vzb during a set-down period may be the same as the slope of the reset signal during a set-down period.

As described above with reference to Table 2, the absolute value of the voltage of the negative voltage signal may be 0.5-0.85 times greater than the absolute value of the second voltage V2.

The voltage of the negative voltage signal may be between the second voltage V2 and a scan bias voltage Vyb, which is applied to the first electrode during an address period.

The width of the last one of a plurality of sustain pulses may be set to be greater than the width of any one of the other sustain pulses. Therefore, it is possible to secure sufficient time period to apply the negative voltage signal to the first electrode and to accumulate sufficient wall charges on the first and second electrodes.

More specifically, the length of the second time period T2 may be greater than the width of any one of the pulses of the sustain signal except for the last pulse of the sustain signal. In this case, it is possible to efficiently accumulate wall charges.

In order to efficiently control the accumulation of wall charges, the second time period T2 may begin after the occurrence of a last discharge during the first time period T1. In this case, no discharge occurs during the second time period T2.

The second time period T2 may be set to be 50-130 times longer than the first time period T1 in consideration of the accumulation of wall charges. For example, if the first time period T1 is 3.34 μs long, the second time period T2 may be 200-400 μs long.

Table 3 shows the relationship between the ratio of the length of the first time period T1 and the length of the second time period T2, the occurrence of a misdischarge and the occurrence of a discharge.

TABLE 3

| Ratio of Length of first | | |
|---|---|---|
| Time Period and | Occurrence of A Mis- | Occurrence of |
| Length of Second Time Period | discharge | Discharge |
| 20 | ◯ | X |
| 30 | ◯ | X |
| 40 | ◯ | X |
| 50 | X | X |
| 60 | X | X |
| 70 | X | X |
| 80 | X | X |
| 90 | X | X |
| 100 | X | X |
| 110 | X | X |
| 120 | X | X |
| 130 | X | X |
| 140 | X | ◯ |
| 150 | X | ◯ |
| 160 | X | ◯ |
| 170 | X | ◯ |
| 180 | X | ◯ |
| 190 | X | ◯ |

Referring to Table 3, if the second time period T2 is 130 or more times longer than the first time period T1, an excessive amount of wall charge may accumulate, and thus, a discharge may occur. On the other hand, if the second time period T2 is 50 or less times longer than the first time period T1, wall charges may not be able to accumulate sufficiently, and thus, a misdischarge may occur due to a shortage of wall charges.

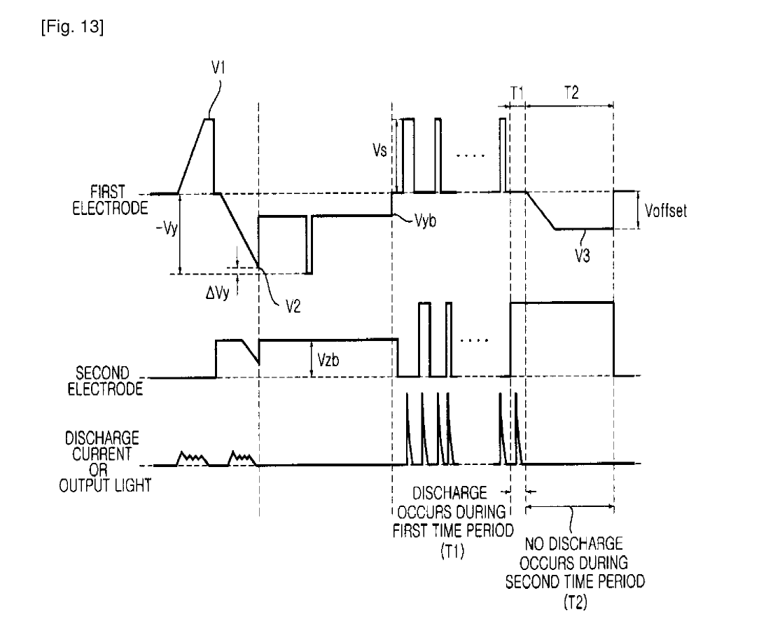

FIG. 13 illustrates a timing diagram of the waveforms of a plurality of driving signals for driving a PDP, according to another exemplary embodiment of the present invention. Referring to FIG. 13, a negative voltage signal may decrease in steps during a second time period T2. More specifically, a negative voltage signal may be divided into two portions: a first portion whose voltage gradually decreases to a third voltage V3 and a second portion whose voltage is maintained at the third voltage V3. In this case, the slope of the first portion of the negative voltage signal may be substantially the same as the slope of a reset signal during a set-down period. Thus, this exemplary embodiment can be implemented without the need of an additional circuit.

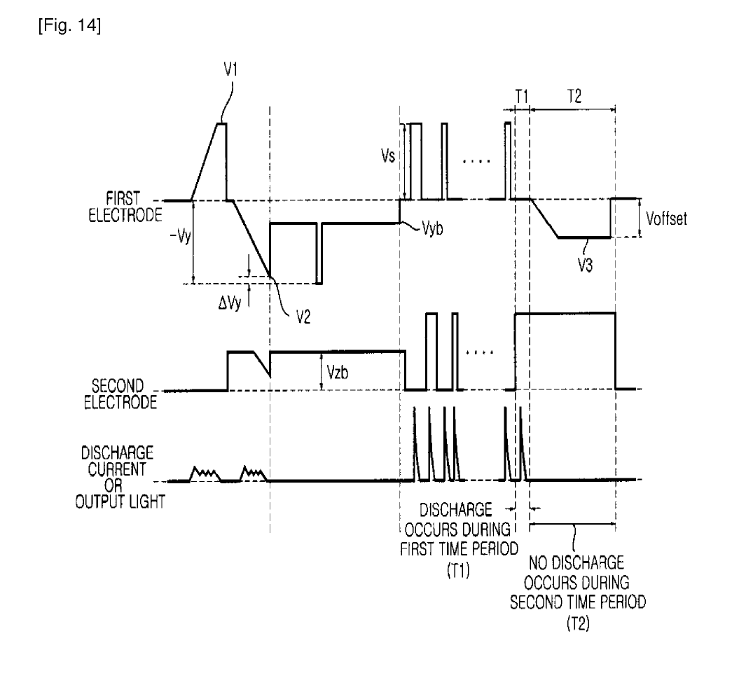

FIG. 14 illustrates a timing diagram of the waveforms of a plurality of driving signals for driving a PDP, according to another exemplary embodiment of the present invention. Referring to FIG. 14, the end of a time period during which a negative voltage signal is applied to the first electrode may not necessarily coincide with the end of a time period during which a sustain signal is applied to the second electrode. More specifically, the time when the voltage of the negative voltage signal increases up to a ground voltage may not coincide with the time when the voltage of the second electrode decreases to the ground voltage. In this case, it is possible to prevent the occurrence of a voltage picking phenomenon that may be caused by turning on or off the switching devices of the first and second electrodes at the same time. The end of the time period during which the negative voltage signal is applied to the first electrode may be set to be earlier than the end of the time period during which the sustain signal is applied to the second electrode in consideration of the application of a voltage to the first and second electrodes.

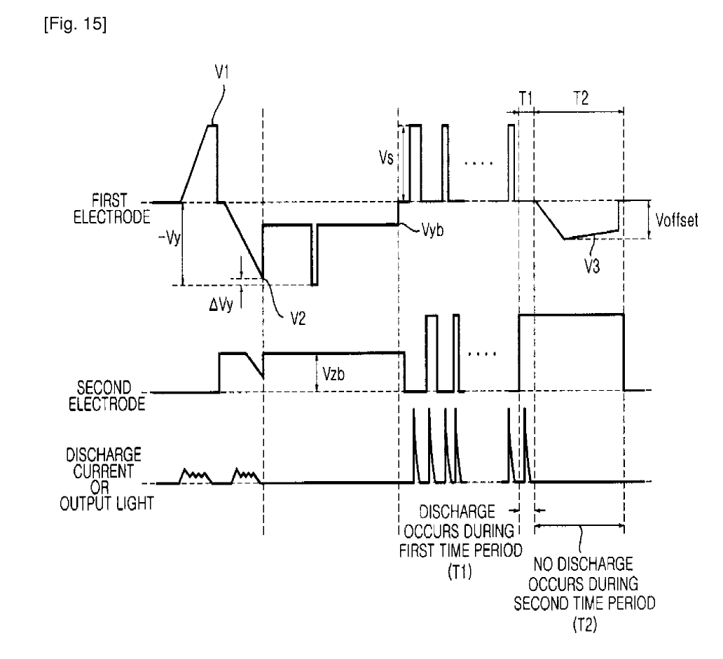

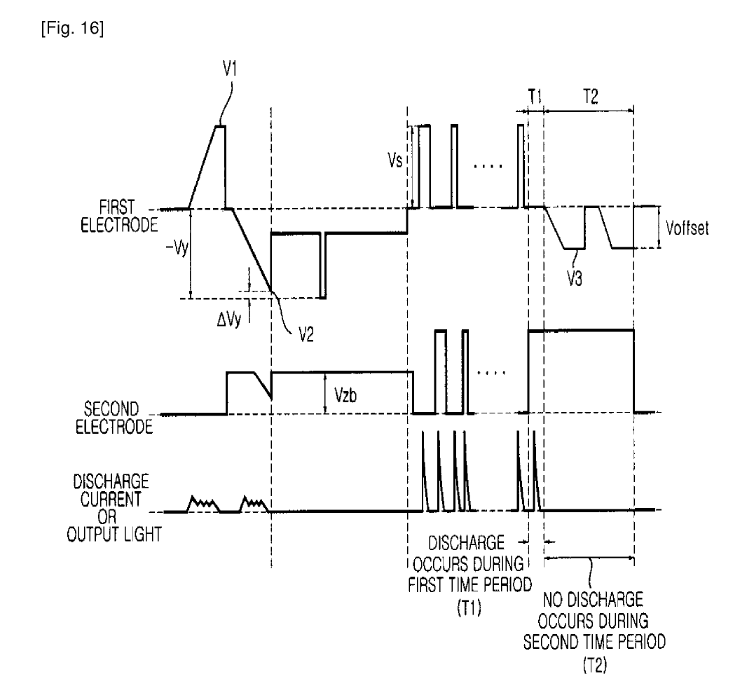

FIGS. 15 and 16 illustrate timing diagrams of the waveforms of a plurality of driving signals for driving a PDP, according to other exemplary embodiments of the present invention. Referring to FIG. 15, if a switching device for supplying a voltage −Vy to the first electrode is opened and thus floated after the application of the negative voltage signal, the voltage of a negative voltage signal may gradually increases from its minimum level.

A time period during which the negative voltage signal is applied to the first electrode may include a third time period during which the voltage of the negative voltage signal gradually decreases and a fourth time period during which the voltage of the negative voltage signal gradually increases. The fourth time period follows the third time period.

If the voltage of the negative voltage signal is too high, a discharge may occur due to a large difference between the voltage of the negative voltage signal and the voltage of a positive voltage signal, which is applied to the second electrode. Thus, it is necessary to accumulate sufficient wall charges by applying a negative voltage signal whose voltage gradually increases with a gentle slope and preventing the voltage of the negative voltage signal from increasing too excessively. It is possible to reduce the difference between the voltage of the negative voltage signal and the voltage of the positive voltage signal by adjusting the time to perform floating so as to control a second time period T2 and to prevent an excessive accumulation of wall charges. The length of the second time period T2 may be adjusted so that an appropriate amount of wall charge can accumulate.

Referring to FIG. 16, a negative voltage signal may be divided into two or more negative voltage sections and a ground voltage section. The accumulation of wall charges may be affected by the length of the negative voltage sections. Thus, it is possible to control the amount of wall charge accumulated and the length of a second time period T2 by adjusting the length of the negative voltage portions.

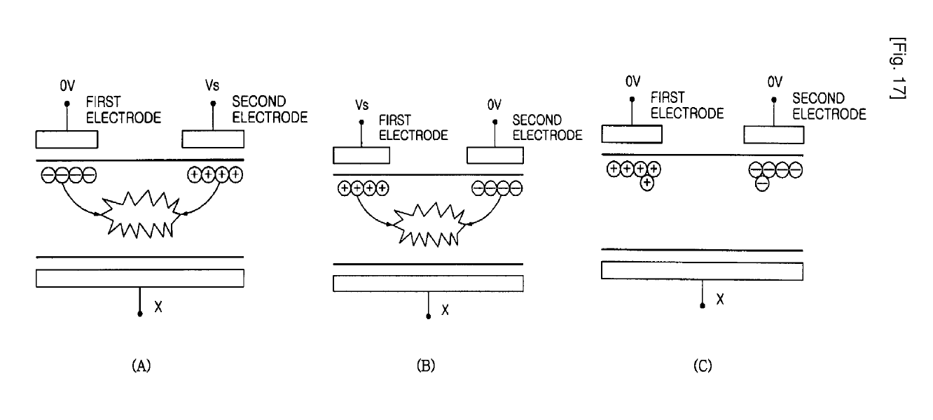

FIGS. 17A through 17C illustrate diagrams for explaining the distribution of wall charges after a number of sustain discharges and the distribution of wall charges after a second time period T2. Referring to FIGS. 17A through 17C, a sustain signal having a sustain voltage Vs is alternately applied to first and second electrodes during a sustain period. Then, a number of surface discharges occur between the first and second electrodes as sustain discharges, as illustrated in FIGS. 17A and 17B. Since sustain discharges are glow discharges, sufficient wall charges may accumulate on the first and second electrodes, and thus, the polarity of the wall charges accumulated on each of the first and second electrodes may be uniformly maintained.

After a last discharge during a first time period T1, the second time period T2 begins. During the second time period T2, a negative voltage signal is applied to the first electrode. Due to the negative voltage signal and the voltage of the second electrode, positive wall charges accumulate on the first electrode, and negative wall charges accumulate on the second electrode, as illustrated in FIG. 17C.

If the absolute value of the voltage of the negative voltage signal is not sufficiently large, wall charges may not be able to accumulate sufficiently. On the other hand, if the absolute value of the voltage of the negative voltage signal is too large, a discharge may occur due to a large difference between the voltage of the negative voltage signal and the voltage of the second electrode, and thus, light leak may occur. In this case, the luminance of dark areas in an image may increase, and thus, the properties of a display device such as contrast ratio may deteriorate.

### INDUSTRIAL APPLICABILITY

As described above, according to the present invention, a negative voltage signal may be applied to the first electrode during the application of a sustain signal, and thus, wall charges may be able to accumulate sufficiently. Therefore, it is possible to reduce the absolute values of predetermined voltages required for causing a discharge such as a sustain voltage and a data voltage and to improve power efficiency.

In addition, according to the present invention, it is possible to improve contrast ratio by preventing the occurrence of a discharge during a second time period T2.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A plasma display device comprising:
a plasma display panel (PDP) including an upper substrate, on which first and second electrodes are formed, and a lower substrate, on which a third electrode is formed; and
a driving unit applying a sustain signal to the first and second electrodes, wherein a negative voltage signal and a positive voltage signal are applied to the first and second electrodes, respectively, after a number of sustain discharges caused by the sustain signal.

2. The plasma display device of claim 1, wherein the absolute value of the voltage of the negative voltage signal is 0.47-0.74 times greater than the absolute value of a sustain voltage.

3. The plasma display device of claim 1, wherein a reset signal whose voltage gradually increases to a first voltage during a set-up period of a reset period and whose voltage gradually decreases to a second voltage during a set-down period of the reset period is applied to the first electrode, and the voltage of the negative voltage signal is lower than the second voltage.

4. The plasma display device of claim 1, wherein the voltage of the negative voltage signal is substantially the same as the sustain voltage.

5. A plasma display device comprising:
a PDP including an upper substrate, on which first and second electrodes are formed, and a lower substrate, on which a third electrode is formed; and
a driving unit applying a sustain signal to the first and second electrodes, wherein a negative voltage signal and a positive voltage signal are applied to the first and second electrodes, respectively, after the occurrence of a number of sustain discharges caused by the sustain signal and no discharge occurs in the PDP during the application of the negative and positive voltage signals.

6. The plasma display device of claim 5, wherein a reset signal whose voltage gradually increases to a first voltage during a set-up period of a reset period and whose voltage gradually decreases to a second voltage during a set-down period of the reset period is applied to the first electrode, and the voltage of the negative voltage signal is lower than the second voltage.

7. The plasma display device of claim 6, wherein the absolute value of the voltage of the negative voltage signal is 0.5-0.85 times greater than the absolute value of the second voltage.

8. The plasma display device of claim 6, wherein a bias voltage is applied to the second electrode during the set-down period.

9. The plasma display device of claim 5, wherein the absolute value of the voltage of the negative voltage signal is less than the absolute value of a sustain voltage.

10. The plasma display device of claim 5, wherein the absolute value of the voltage of the negative voltage signal is 0.47-0.74 times greater than the absolute value of a sustain voltage.

11. The plasma display device of claim 5, wherein a time period during which the negative voltage signal is applied to the first electrode includes a voltage-drop time period during which the voltage of the negative voltage signal gradually decreases to a third voltage and a voltage maintaining time period during which the voltage of the negative voltage signal is maintained at the third voltage.

12. The plasma display device of claim 11, wherein a signal having the voltage-drop time period and the voltage-maintaining time period is applied two or more times to the first electrode during the application of the negative voltage signal to the first electrode.

13. The plasma display device of claim 11, wherein a reset signal whose voltage gradually increases to a first voltage during a set-up period of a reset period and whose voltage gradually decreases to a second voltage during a set-down period of the reset period is applied to the first electrode, and the slope of the reset signal during the set-down period is substantially the same as the slope of the negative voltage signal during the voltage-drop time period.

14. The plasma display device of claim 5, wherein a time period during which the negative voltage signal is applied to the first electrode includes a voltage-drop time period during which the voltage of the negative voltage signal gradually decreases and a voltage-increase time period during which the voltage of the negative voltage signal gradually increases, the fourth time period following the third time period.

15. A plasma display device comprising:
a PDP including an upper substrate, on which first and second electrodes are formed, and a lower substrate, on which a third electrode is formed; and
a driving unit applying a sustain signal to the first and second electrodes, wherein a time period during which the last one of a plurality of sustain pulses of the sustain signal is applied includes a first time period during which a sustain voltage is applied to the second electrode and a second time period during which a negative voltage signal and a positive voltage signal are applied to the first and second electrodes, respectively, the second time period following the first time period.

16. The plasma display device of claim 15, wherein the width of the last pulse of the sustain signal is greater than the width of any one of the other pulses of the sustain signal.

17. The plasma display device of claim 15, wherein the second time period is 50-100 times longer than the first time period.

18. The plasma display device of claim 15, wherein no discharge occurs during the second time period.

19. The plasma display device of claim 15, wherein the voltage of the negative voltage signal applied to the first electrode during the second time period gradually decreases to a third voltage and is then maintained at the third voltage.

20. The plasma display device of claim 15, wherein the width of the second time period is greater than the width of any one of the pulses of the sustain signal except for the last pulse of the sustain signal.
